(19) United States
(12) Patent Application Publication
(10) Pub. No.: US 2025/0357696 A1
(43) Pub. Date: Nov. 20, 2025

(54) CONNECTOR AND CONNECTOR ASSEMBLY

(71) Applicants: Tyco Electronics (Dongguan) Ltd., Dongguan City (CN); Tyco Electronics (Shanghai) Co., Ltd., Shanghai (CN)

(72) Inventors: Huakun (Walker) Wei, Dongguan (CN); William (Wei) Yao, Kunshan (CN); Zhiwei (Will) Liu, Dongguan (CN); Qianjin (Orando) Li, Shanghai (CN)

(73) Assignees: Tyco Electronics (Dongguan) Ltd., Dongguan City (CN); Tyco Electronics (Shanghai) Co., Ltd., Shanghai (CN)

(21) Appl. No.: 19/209,881

(22) Filed: May 16, 2025

(30) Foreign Application Priority Data
May 16, 2024 (CN) 202410612858.7

(51) Int. Cl. H01R 13/508; H01R 13/04; H01R 13/74

(52) U.S. Cl. CPC H01R 13/508; H01R 13/04; H01R 13/748

(57) ABSTRACT

A connector includes a housing, a pair of plate-shaped terminals, a pair of connecting plates and a support block. The housing has front and rear ends that are opposite in its longitudinal direction. The pair of plate-shaped terminals are installed in the housing and spaced opposite each other in a transverse direction of the housing. The pair of connecting plates are respectively connected to rear ends of the pair of plate-shaped terminals and extend from the rear end of the housing. The support block is arranged outside the housing and is supported between the pair of connecting plates to prevent a clamping force applied to the pair of connecting plates from being transmitted to the housing.

### CROSS-REFERENCE TO RELATED APPLICATION

This application claims the benefit of Chinese Patent Application No. CN202410612858.7 filed on May 16, 2024 in the State Intellectual Property Office of China, the whole disclosure of which is incorporated herein by reference.

### FIELD OF THE DISCLOSURE

This disclosure relates to a connector and a connector assembly comprising the connector.

### BACKGROUND OF THE INVENTION

In the prior art, a connector typically includes a housing, a pair of plate-shaped terminals, and a pair of connecting plates. The pair of plate-shaped terminals are installed in the housing and spaced opposite each other in the transverse direction of the housing. The pair of connecting plates are respectively connected to the rear ends of the pair of plate-shaped terminals and extend from the rear end of the housing, for electrical connection to the electrical transmission components. In the prior art, a pair of limiting ribs are respectively formed on the top wall and bottom wall of the housing. The pair of limiting ribs are respectively pressed against the inner sides of the front ends of the pair of connecting plates, used to position the connecting plates and plate-shaped terminals in the transverse direction of the housing.

In the prior art, when installing the connector onto the mounting panel, the operator usually holds the pair of connection plates of the connector with one hand and tightens the bolt with the other hand. However, when gripping the pair of connecting plates of the connector, the pair of connecting plates will experience a significant clamping force, which will be directly transmitted to the pair of limiting ribs of the housing. Due to the fact that the housing is usually made of plastic material and the pair of limiting ribs are very thin, this can result in damage to the limiting ribs and the connector being scrapped.

### SUMMARY OF THE INVENTION

According to an embodiment of the present disclosure, a connector includes a housing, a pair of plate-shaped terminals, a pair of connecting plates and a support block. The housing has front and rear ends that are opposite in its longitudinal direction. The pair of plate-shaped terminals are installed in the housing and spaced opposite each other in a transverse direction of the housing. The pair of connecting plates are respectively connected to rear ends of the pair of plate-shaped terminals and extend from the rear end of the housing. The support block is arranged outside the housing and is supported between the pair of connecting plates to prevent a clamping force applied to the pair of connecting plates from being transmitted to the housing.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a connector according to an exemplary embodiment of the present invention when viewed from the front side;

FIG. 2 shows an illustrative perspective view of a connector according to an exemplary embodiment of the present invention when viewed from the rear side;

FIG. 3 shows a longitudinal sectional view of a connector according to an exemplary embodiment of the present invention;

FIG. 4 shows an illustrative exploded view of a connector according to an exemplary embodiment of the present invention;

FIG. 5 shows an illustrative perspective view of a pair of plate-shaped terminals, a pair of connection plates, and a support block of a connector according to an exemplary embodiment of the present invention;

FIG. 6 shows an illustrative perspective view of a support block of a connector according to an exemplary embodiment of the present invention;

FIG. 7 shows a transverse sectional view of a connector according to an exemplary embodiment of the present invention;

FIG. 8 shows an illustrative perspective view of the plate-shaped terminals and connecting plate of a connector according to an exemplary embodiment of the present invention when viewed from the outside;

FIG. 9 shows an illustrative exploded view of a plate-shaped terminal of a connector according to an exemplary embodiment of the present invention;

FIG. 10 shows a longitudinal sectional view of a plate-shaped terminal and a connecting plate of a connector according to an exemplary embodiment of the present invention;

FIG. 11 shows an illustrative perspective view of the plate-shaped terminals and connecting plate of a connector according to an exemplary embodiment of the present invention when viewed from the inside; and

FIG. 12 shows an illustrative exploded view of the housing and grounding spring of a connector according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a connector comprises: a housing which has front and rear ends that are opposite in its longitudinal direction; a pair of plate-shaped terminals installed in the housing and spaced opposite each other in the transverse direction of the housing; a pair of connecting plates, respectively connected to the rear ends of the pair of plate-shaped terminals and extending from the rear end of the housing; and a support block which is located outside the housing and supported between the pair of connecting plates to prevent a clamping force applied to the pair of connecting plates from being transmitted to the housing.

According to another embodiment described herein, a connector assembly comprises the above connector; and a mating connector which is mated with the connector.

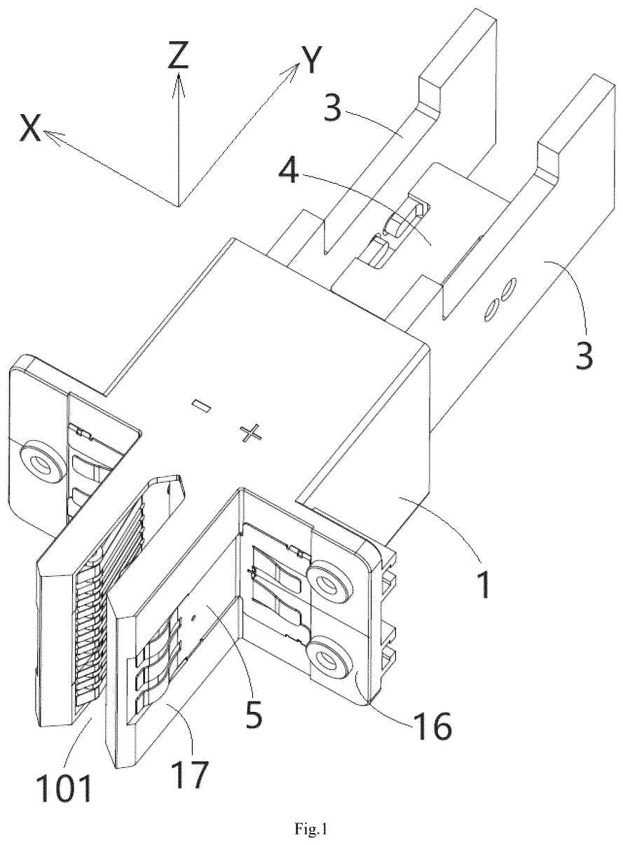

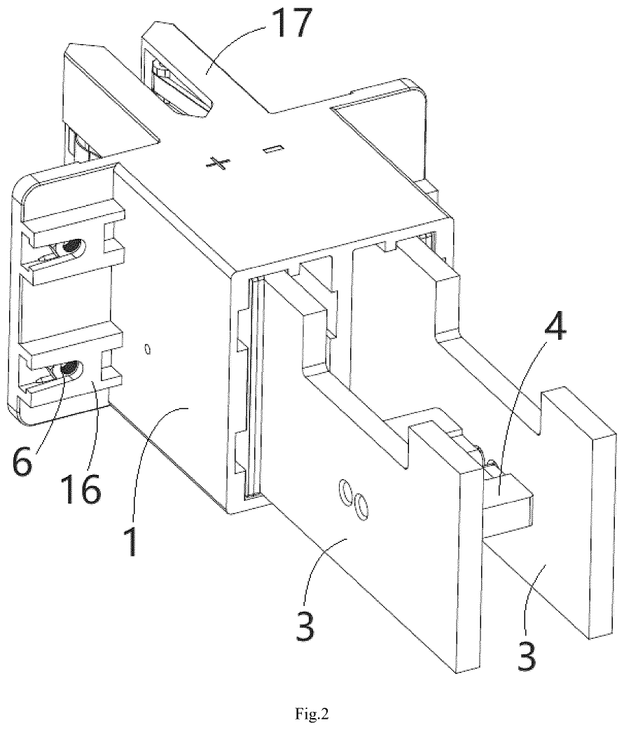

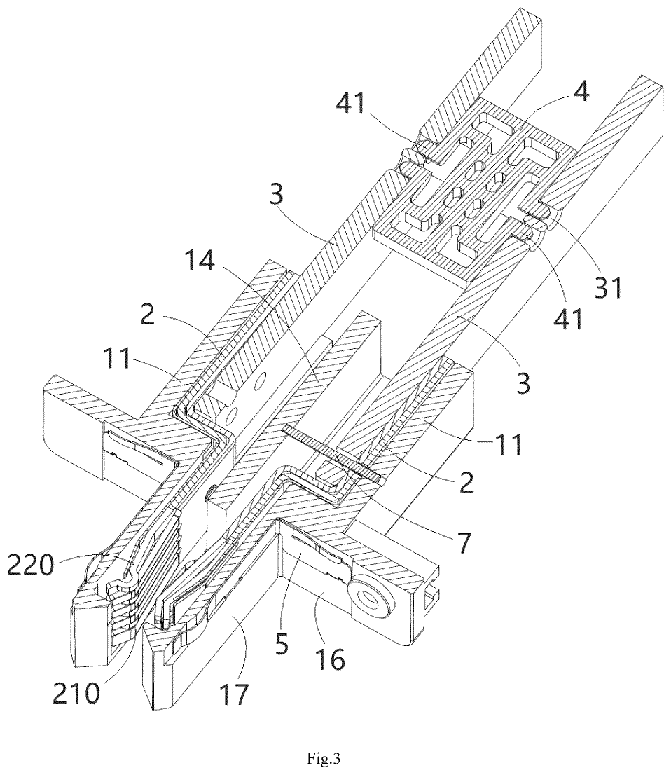

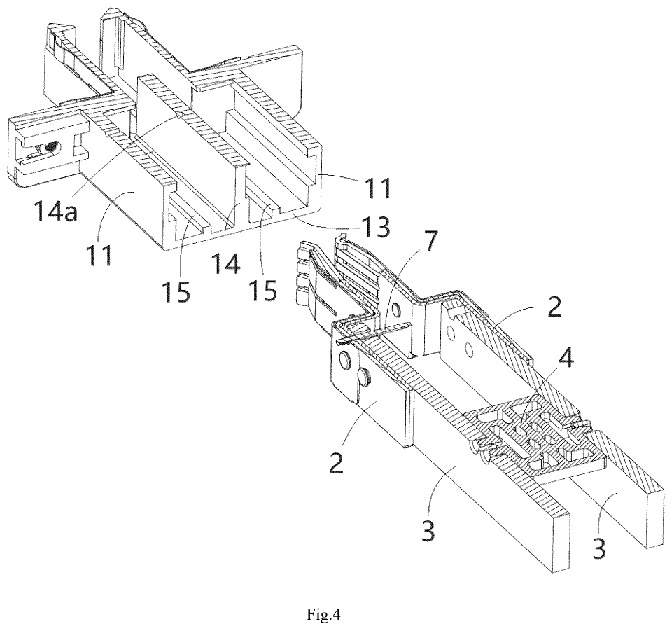

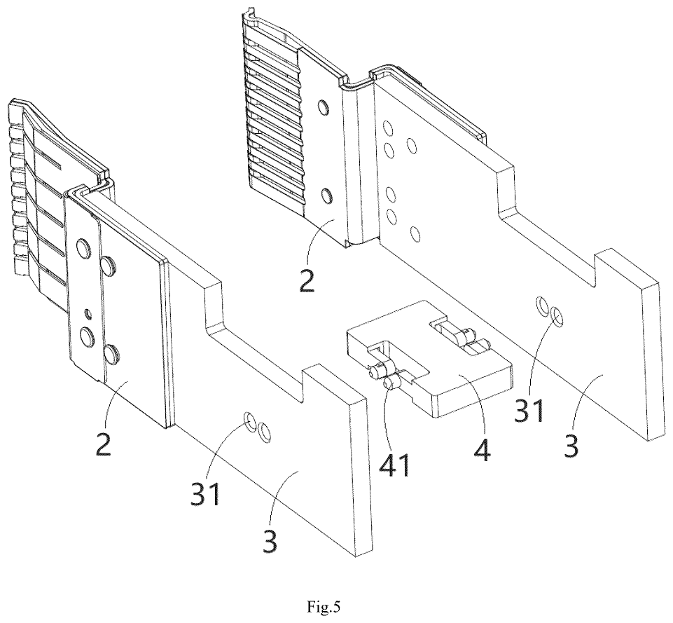

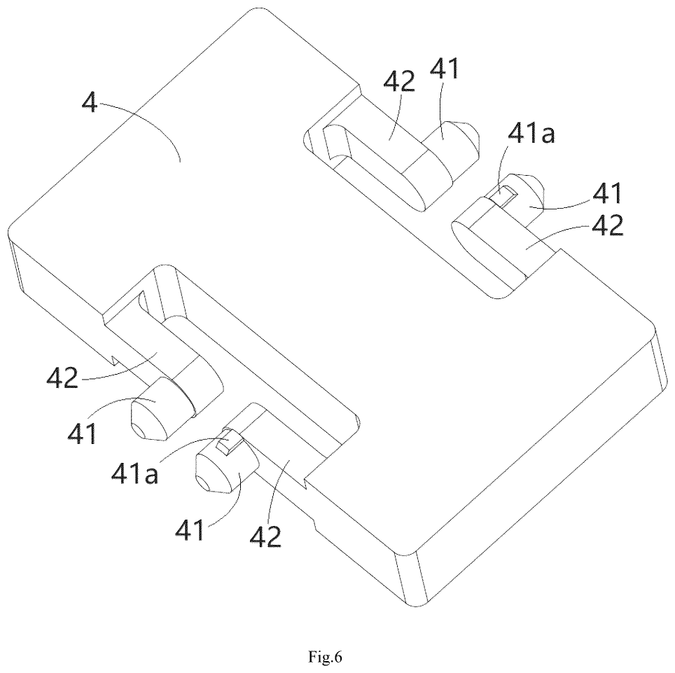

FIG. 1 shows an illustrative perspective view of a connector according to an exemplary embodiment of the present invention when viewed from the front side; FIG. 2 shows an illustrative perspective view of a connector according to an exemplary embodiment of the present invention when viewed from the rear side; FIG. 3 shows a longitudinal sectional view of a connector according to an exemplary embodiment of the present invention; FIG. 4 shows an illustrative exploded view of a connector according to an exemplary embodiment of the present invention; FIG. 5 shows an illustrative perspective view of a pair of plate-shaped terminals 2, a pair of connection plates 3, and a support block 4 of a connector according to an exemplary embodiment of the present invention; FIG. 6 shows an illustrative perspective view of the support block 4 of a connector according to an exemplary embodiment of the present invention.

As shown in FIGS. 1 to 6, in an exemplary embodiment of the present invention, a connector is disclosed. The connector includes: a housing 1, a pair of plate-shaped terminals 2, a pair of connecting plates 3, and a support block 4. The housing 1 has front and rear ends that are opposite in its longitudinal direction Y. The pair of plate-shaped terminals 2 are installed in the housing 1 and spaced opposite each other in the transverse direction X of the housing 1. The pair of connecting plates 3 are respectively connected to the rear ends of the pair of plate-shaped terminals 2 and extend from the rear end of the housing 1, for electrical connection to electrical transmission components (not shown). The support block 4 is located outside the housing 1 and supported between the pair of connecting plates 3 to prevent the clamping force applied to the pair of connecting plates 3 from being transmitted to the housing 1.

As shown in FIGS. 1 to 6, in the illustrated embodiment, the pair of connecting plates 3 are perpendicular to the transverse direction X of the housing 1 and spaced apart by a predetermined distance. The width of the support block 4 in the transverse direction X of the housing 1 is equal to the predetermined distance to ensure that the distance between the pair of connecting plates 3 when clamped is still equal to the predetermined distance.

As shown in FIGS. 1 to 6, in the illustrated embodiment, the thickness of the support block 4 in the height direction Z of the housing 1 is smaller than the width of the support block 4 in the transverse direction X of the housing 1, in order to reduce the wind resistance of the support block 4 in the longitudinal direction Y of the housing 1. This will not affect the heat dissipation performance of the connector.

As shown in FIGS. 1 to 6, in the illustrated embodiment, the width of the support block 4 in the transverse direction X of the housing 1 is smaller than the length of the support block 4 in the longitudinal direction Y of the housing 1.

As shown in FIGS. 1 to 6, in the illustrated embodiment, the support block 4 has two opposite sides in the transverse direction X of the housing 1, and pins 41 extending along the transverse direction X of the housing 1 are formed on each side of the support block 4. The pair of connecting plates 3 are respectively formed with pin holes 31 extending along the transverse direction X of the housing 1, and pins 41 are respectively inserted into the pin holes 31 to install the support block 4 between the pair of connecting plates 3.

As shown in FIGS. 1 to 6, in the illustrated embodiment, an axially extending rib 41a is formed on the pin 41, which is in interference fit with the inner wall of the pin hole 31 to fix the pin 41 into the pin hole 31.

As shown in FIGS. 1 to 6, in the illustrated embodiment, a pair of support arms 42 are formed on both sides of the support block 4, the pair of support arms 42 extends along the longitudinal direction Y of the housing 1 and face each other in the longitudinal direction Y, and the pin 41 is formed on the end of each of the support arms 42.

It should be understood that the present invention is not limited to the illustrated embodiment. For example, in another exemplary embodiment of the present invention, the support block 4 may be an injection molded part directly injected onto the pair of connecting plates 3, such that the pair of connecting plates 3 and the support block 4 become an integral piece.

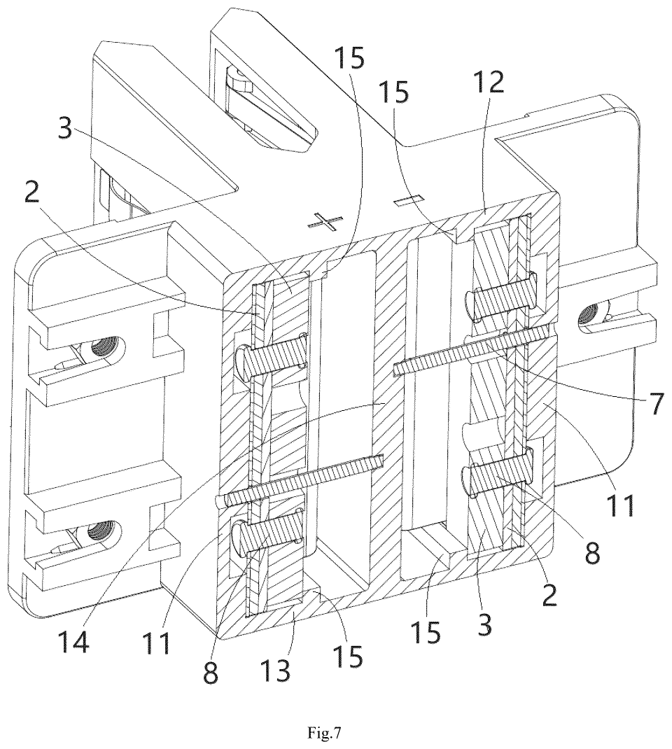

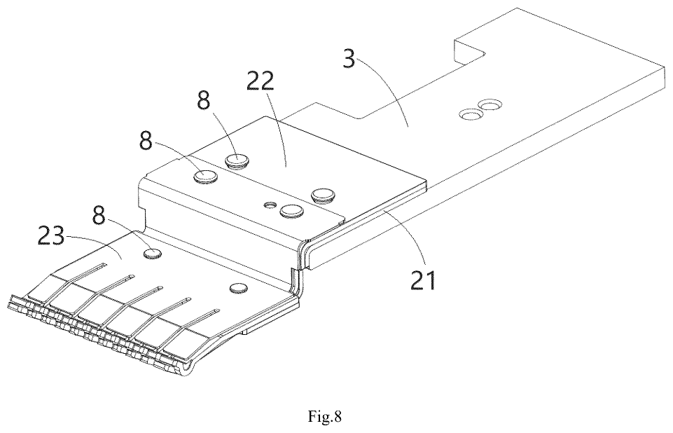

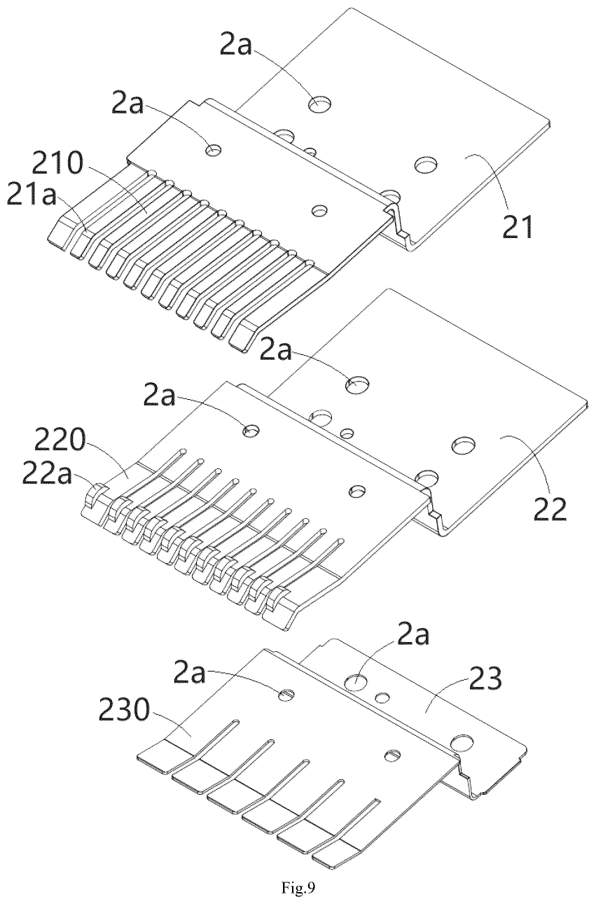

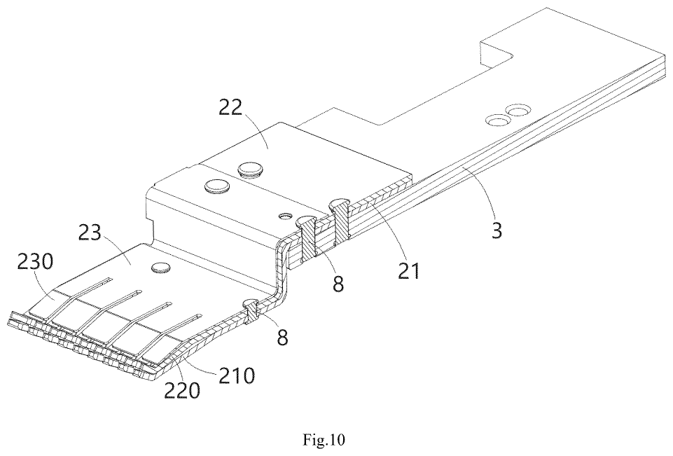

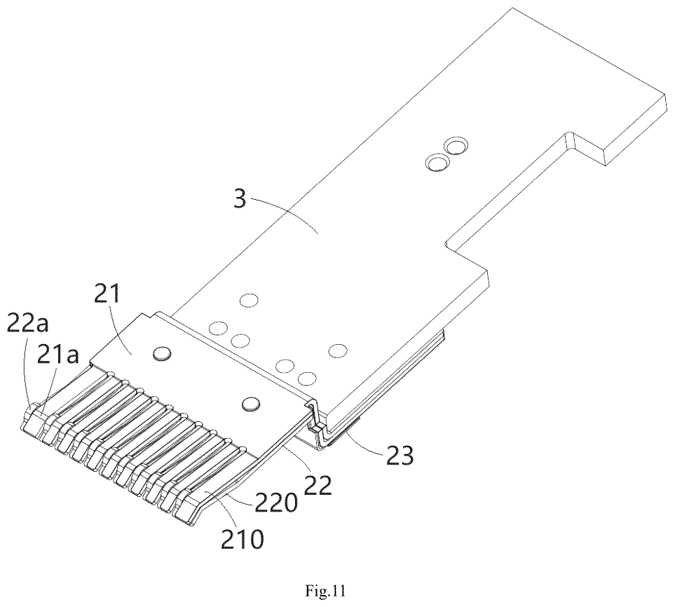

FIG. 7 shows a transverse sectional view of a connector according to an exemplary embodiment of the present invention; FIG. 8 shows an illustrative perspective view of the plate-shaped terminal 2 and the connecting plate 3 of the connector according to an exemplary embodiment of the present invention when viewed from the outside; FIG. 9 shows an illustrative exploded view of the plate-shaped terminal 2 of a connector according to an exemplary embodiment of the present invention; FIG. 10 shows a longitudinal sectional view of the plate-shaped terminal 2 and the connecting plate 3 of a connector according to an exemplary embodiment of the present invention; FIG. 11 shows an illustrative perspective view of the plate-shaped terminal 2 and the connecting plate 3 of the connector according to an exemplary embodiment of the present invention when viewed from the inside.

As shown in FIGS. 1 to 11, in the illustrated embodiment, the housing 1 has two opposite side walls 11 in its transverse direction X, as well as a top wall 12 and a bottom wall 13 opposite in its height direction Z. The rear ends of the pair of plate-shaped terminals 2 are respectively riveted to the outer sides of the front ends of the pair of connecting plates 3, and the outer sides of the rear ends of the pair of plate-shaped terminals 2 are respectively pressed against the inner sides of the two side walls 11 of the housing 1. A pair of limiting ribs 15 are respectively formed on the top wall 12 and bottom wall 13 of the housing 1, and the pair of limiting ribs 15 are pressed against the inner sides of the front ends of the pair of connecting plates 3, respectively.

As shown in FIGS. 1 to 11, in the illustrated embodiment, rivet holes 2a are formed in the rear end of the plate-shaped terminal 2 and the front end of the connecting plate 3, respectively. The connector also includes rivet pins 8 that pass through the rivet holes 2a. The rear end of the plate-shaped terminal 2 and the front end of the connecting plate 3 are riveted together by the rivet pins 8.

As shown in FIGS. 1 to 11, in the illustrated embodiment, the housing 1 also has a partition wall 14 located between the rear ends of the pair of plate-shaped terminals 2. The partition wall 14 is connected between the top wall 12 and the bottom wall 13 of the housing 1, and two positioning holes 14a are formed in the partition wall 14. The connector also includes two positioning pins 7, which pass through the rear ends of the pair of plate-shaped terminals 2 and the front ends of the pair of connecting plates 3 along the transverse direction X of the housing 1, and are respectively inserted into the pair of positioning holes 14a in the partition wall 14 to position the pair of plate-shaped terminals 2 in the longitudinal direction Y and the height direction Z.

As shown in FIGS. 1 to 11, in the illustrated embodiment, the plate-shaped terminal 2 includes a first plate-shaped terminal 21 and a second plate-shaped terminal 22. The second plate-shaped terminal 22 is stacked on the outer side of the first plate-shaped terminal 21. A row of first elastic arms 210 is formed at the front end of the first plate-shaped terminal 21, and a row of second elastic arms 220 is formed at the front end of the second plate-shaped terminal 22, with the row of second elastic arms 220 resting against the outer side of the row of first elastic arms 210. A first contact point 1a is formed on the end of the first elastic arm 210, and a second contact point 22 is formed on the end of the second elastic arm 220. The first contact point 21 and the second contact point 22 of the plate-shaped terminal 2 are arranged in an alternating manner in a row for simultaneous electrical contact with a side of the mating plug inserted between the front ends of the pair of plate-shaped terminals 2.

As shown in FIGS. 1 to 11, in the illustrated embodiment, the plate-shaped terminal 2 further includes a plate-shaped auxiliary spring piece 23, which is stacked on the outer side of the second plate-shaped terminal 22. A row of auxiliary elastic arms 230 is formed at the front end of the plate-shaped auxiliary spring piece 23, and the row of auxiliary elastic arms 230 is pressed against the outer side of the row of second elastic arms 220, used to apply auxiliary contact pressure to the first elastic arms 210 and the second elastic arms 220, to ensure reliable electrical contact between the first contact point 21a and the second contact point 22a and the mating plug.

As shown in FIGS. 1 to 11, in the illustrated embodiment, a rivet hole 2a is formed in the plate-shaped terminal 2, and the rivet hole 2a penetrates through the plate-shaped auxiliary spring 23, the first plate-shaped terminal 21, and the second plate-shaped terminal 22 along the transverse direction X of the housing 1. The connector also includes a rivet pin 8, which passes through the rivet hole 2a. The plate-shaped auxiliary spring 23, the first plate-shaped terminal 21, and the second plate-shaped terminal 22 are riveted together by the rivet pin 8.

As shown in FIGS. 1 to 11, in the illustrated embodiment, the housing 1 has a flange part 16 suitable for installation onto a mounting panel (not shown) and a front housing part 17 extending forward from the flange part 16. A slot 101 is formed in the front housing part 17. The first elastic arms 210 and the second elastic arms 220 are located in the slot 101 for electrical contact with a mating plug (not shown) of a mating connector (not shown) inserted into the slot 101.

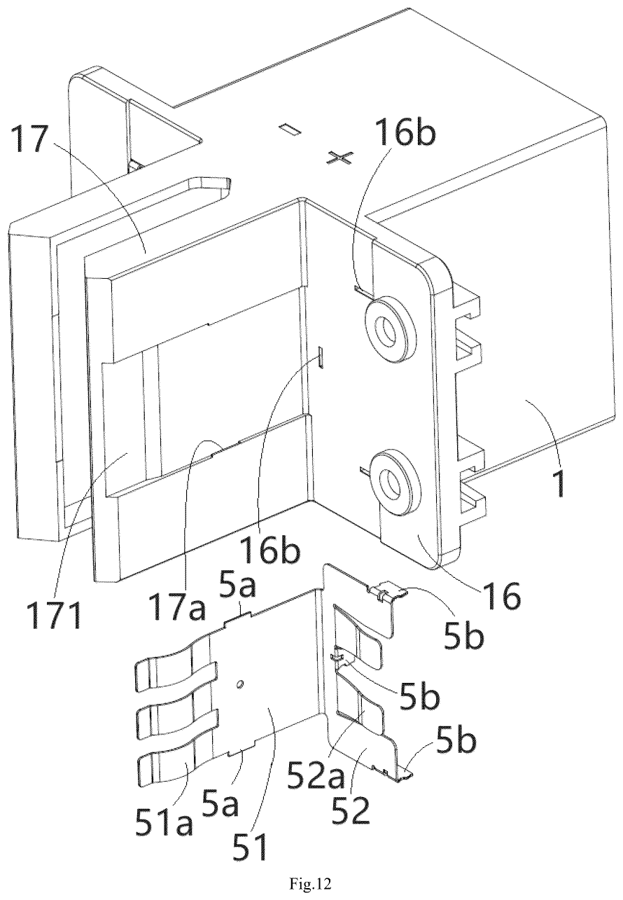

FIG. 12 shows an illustrative exploded view of the housing 1 and grounding spring 5 of a connector according to an exemplary embodiment of the present invention.

As shown in FIGS. 1 to 12, in the illustrated embodiment, the connector further comprises a pair of grounding springs 5, which are respectively located on the lateral two sides of the front housing part 17 and fixed to the front housing part 17 and the flange part 16. The grounding spring 5 is used to make electrical contact with the mounting panel and a mating grounding piece (not shown) of the mating connector simultaneously.

As shown in FIGS. 1 to 12, in the illustrated embodiment, the grounding spring 5 includes a first base plate 51 and a second base plate 52. The first base plate 51 is attached to the outer side of the front housing part 17 and has a first contact spring 51a formed on it. The second base plate 52 is attached to the front side of the flange part 16 and formed with a second contact spring 52a on it. The first base plate 51 is vertically connected to the second base plate 52, so that the grounding spring 5 is L-shaped. The first contact spring 51a is used to make electrical contact with the mating grounding piece, and the second contact spring 52a is used to make electrical contact with the mounting panel.

As shown in FIGS. 1 to 12, in the illustrated embodiment, a recess 171 suitable for mating with the first base plate 51 is formed on the outer side of the front housing part 17, and the first base plate 51 is embedded in the recess 171. A first tongue 5a is formed on each of the upper and lower sides of the first base plate 51, which is flush with the surfaces of the first base plate 51. A first slot 17a is also formed in the front housing part 17, and the first tongue 5a is inserted into the first slot 17a to fix the first base plate 51 to the outer side of the front housing part 17.

As shown in FIGS. 1 to 12, in the illustrated embodiment, a second tongue 5b perpendicular to the second base plate 52 is formed on the second base plate 52, and a second slot 16b is formed in the front side of the flange part 16. The second tongue 5b is inserted into the second slot 16b to fix the second base plate 52 to the front side of the flange part 16.

As shown in FIGS. 1 to 12, in the illustrated embodiment, multiple second tongues 5b are formed on the second base plate 52, the multiple second tongues 5b includes a vertical tongue perpendicular to the transverse direction X of the housing 1 and a horizontal tongue perpendicular to the height direction Z of the housing 1.

As shown in FIGS. 1 to 12, in the illustrated embodiment, the connector further comprises a nut 6, which is embedded into the flange part 16 for threaded connection with bolts passing through the mounting panel to fix the housing 1 to the mounting panel.

As shown in FIGS. 1 to 12, in the illustrated embodiment, the connector further comprises an electrical transmission component, which is electrically connected to the rear end of the connecting plate 3 of the connector. The electrical transmission component can be a cable or a busbar used for transmitting current.

As shown in FIGS. 1 to 12, in another exemplary embodiment of the present invention, a connector assembly is also disclosed. The connector assembly includes the aforementioned connector and a mating connector. The mating connector is mated with the connector.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
a housing which has front and rear ends that are opposite in its longitudinal direction;
a pair of plate-shaped terminals installed in the housing and spaced opposite each other in the transverse direction of the housing;
a pair of connecting plates, respectively connected to the rear ends of the pair of plate-shaped terminals and extending from the rear end of the housing; and
a support block which is located outside the housing and supported between the pair of connecting plates to prevent a clamping force applied to the pair of connecting plates from being transmitted to the housing.

2. The connector according to claim 1, wherein the pair of connecting plates are perpendicular to the transverse direction of the housing and spaced apart by a predetermined distance, the width of the support block in the transverse direction of the housing is equal to the predetermined distance to ensure that the distance between the pair of connecting plates when clamped is still equal to the predetermined distance.

3. The connector according to claim 1, wherein the thickness of the support block in the height direction of the housing is smaller than the width of the support block in the transverse direction of the housing, in order to reduce the wind resistance of the support block in the longitudinal direction of the housing.

4. The connector according to claim 3, wherein the width of the support block in the transverse direction of the housing is smaller than the length of the support block in the longitudinal direction of the housing.

5. The connector according to claim 1, wherein:
the support block has two opposite sides in the transverse direction of the housing, and pins extending along the transverse direction of the housing are formed on each side of the support block; and
pin holes extending along the transverse direction of the housing are respectively formed in the pair of connecting plates, and the pins are inserted into the pin holes to install the support block between the pair of connecting plates.

6. The connector according to claim 5, wherein an axially extending rib is formed on the pin, which is in interference fit with the inner wall of the pin hole to fix the pin into the pin hole.

7. The connector according to claim 6, wherein a pair of support arms are formed on each side of the support block, the pair of support arms extend along the longitudinal direction of the housing and face each other in the longitudinal direction, and pins are respectively formed on the ends of the pair of support arms.

8. The connector according to claim 1, wherein the support block is an injection molded part directly injected onto the pair of connecting plates, so that the pair of connecting plates and the support block are formed into an integral piece.

9. The connector according to claim 1, wherein:
the housing has two opposite side walls in its transverse direction and a top wall and a bottom wall opposite in its height direction;
the rear ends of the pair of plate-shaped terminals are respectively riveted to the outer sides of the front ends of the pair of connecting plates, and the outer sides of the rear ends of the pair of plate-shaped terminals are respectively pressed against the inner sides of the two side walls of the housing; and
a pair of limiting ribs are respectively formed on the top wall and bottom wall of the housing, and the pair of limiting ribs are respectively pressed against the inner sides of the front ends of the pair of connecting plates.

10. The connector according to claim 9, wherein rivet holes are respectively formed in the rear end of the plate-shaped terminal and the front end of the connecting plate, and the connector further comprises a rivet pin passing through the rivet hole, the rear end of the plate-shaped terminal and the front end of the connecting plate are riveted together through the rivet pin.

11. The connector according to claim 9, wherein:
the housing also has a partition wall located between the rear ends of the pair of plate-shaped terminals, the partition wall is connected between the top wall and the bottom wall of the housing, and two positioning holes formed in the partition wall; and
the connector further comprises two positioning pins, which pass through the rear ends of the pair of plate-shaped terminals and the front ends of the pair of connecting plates along the transverse direction of the housing, and are respectively inserted into the pair of positioning holes in the partition wall to position the pair of plate-shaped terminals in the longitudinal direction and the height direction.

12. The connector according to claim 1, wherein the plate-shaped terminal comprises:
a first plate-shaped terminal; and
a second plate-shaped terminal which is stacked on the outer side of the first plate-shaped terminal, wherein:
a row of first elastic arms is formed at the front end of the first plate-shaped terminal, and a row of second elastic arms is formed at the front end of the second plate-shaped terminal, which abut against the outer side of the row of first elastic arms; and
a first contact point is formed on the end of the first elastic arm, and a second contact point is formed on the end of the second elastic arm, the first contact point and the second contact point of the plate-shaped terminal are arranged in an alternating manner in a row for simultaneous electrical contact with a side of a mating plug inserted between the front ends of the pair of plate-shaped terminals.

13. The connector according to claim 12, wherein the plate-shaped terminal further comprises a plate-shaped auxiliary spring piece which is stacked on the outer side of the second plate-shaped terminal, a row of auxiliary elastic arms is formed at the front end of the plate-shaped auxiliary spring piece, and the row of auxiliary elastic arms is pressed against the outer side of the row of second elastic arms, used to apply auxiliary contact pressure to the first elastic arms and the second elastic arms to ensure reliable electrical contact between the first contact point and the second contact point and the mating plug.

14. The connector according to claim 13, wherein:
a rivet hole is formed in the plate-shaped terminal, and the rivet hole penetrates through the plate-shaped auxiliary spring piece, the first plate-shaped terminal, and the second plate-shaped terminal along the transverse direction of the housing; and
the connector further comprises a rivet pin that passes through the rivet hole, and the plate-shaped auxiliary spring piece, the first plate-shaped terminal, and the second plate-shaped terminal are riveted together by the rivet pin.

15. The connector according to claim 12, wherein the housing has a flange part suitable for installation onto a mounting panel and a front housing part extending forward from the flange part, a slot is formed in the front housing part, and the first elastic arms and the second elastic arms are located in the slot for electrical contact with a mating plug of a mating connector inserted into the slot.

16. The connector according to claim 15, further comprising a pair of grounding springs which are respectively located on the two sides of the front housing part and fixed to the front housing part and the flange part, wherein the grounding spring is used to make electrical contact with the mounting panel and a mating grounding piece of the mating connector simultaneously.

17. The connector according to claim 16, wherein the grounding spring comprises:
a first base plate which is attached to the outer side of the front housing part and has a first contact spring formed on it; and
a second base plate which is attached to the front side of the flange part and has a second contact spring formed on it, wherein the first base plate is vertically connected to the second base plate, so that the grounding spring is L-shaped, the first contact spring is used to make electrical contact with the mating grounding piece, and the second contact spring is used to make electrical contact with the mounting panel.

18. The connector according to claim 17, wherein:
a recess suitable for mating with the first base plate is formed on the outer side of the front housing part, and the first base plate is embedded in the recess; and
a first tongue is formed on each of the upper and lower sides of the first base plate, which is flush with the surfaces of first base plate, a first slot is formed in the front housing part, and the first tongue is inserted into the first slot to fix the first base plate to the outer side of the front housing part.

19. The connector according to claim 17, wherein a second tongue perpendicular to the second base plate is formed on the second base plate, and a second slot is formed in the front side of the flange part, the second tongue is inserted into the second slot to fix the second base plate to the front side of the flange part.

20. The connector according to claim 19, wherein multiple second tongues are formed on the second base plate, the multiple second tongues include a vertical tongue perpendicular to the transverse direction of the housing and a horizontal tongue perpendicular to the height direction of the housing.

21. The connector according to claim 15, further comprising a nut embedded into the flange part for threaded connection with a bolt passing through the mounting panel to secure the housing to the mounting panel.

22. The connector according to claim 1, further comprising an electrical transmission component electrically connected to the rear end of the connecting plate of the connector.

23. The connector according to claim 22, wherein the electrical transmission component is a cable or a busbar used for transmitting current.
